(19) United States
(12) Patent Application Publication
(10) Pub. No.: US 2003/0028874 A1
(43) Pub. Date: Feb. 6, 2003

(54) Channel set system and switching device

(76) Inventor: Siegfried Huber, Reichertshofen (DE)

Correspondence Address: BELL, BOYD & LLOYD, LLC, P. O. BOX 1135, CHICAGO, IL, 60690-1135, US

(21) Appl. No.: 09/921,216

(22) Filed: Aug. 2, 2001

(30) Foreign Application Priority Data
Aug. 2, 2001 (EP) 00116724.6

(51) Int. Cl. G06F 3/00; H04N 5/445; G06F 13/00; H04L 12/28; H04N 5/44

(52) U.S. Cl. 725/37; 370/431; 348/725

(57) ABSTRACT

In a system KBS of up to N channels which are addressed linearly using channel addresses 0 . . . N−1, channel sets KB are formed by intermittent, that is to say in which at least some channel addresses are omitted, allocation of channels. For example, when switching systems are upgraded by adding further switching modules KM, this advantageously allows the scope of the channel sets KB to be changed without restricting the free access capability from output stages AS with single and double throughput.

### BACKGROUND OF THE INVENTION

The present invention relates to a channel set system, and to a switching device employing such channel set system, wherein the channel set system has particular features enabling a much improved association between the channel sets and the individual channels which are combined to form such channel sets.

In present-day communications networks, information streams are frequently transmitted using channel sets. This is regularly the situation when the capacity of a single channel is less than the capacity which is required for transmitting an information stream.

One example of this occurs in the migration of the continuous information streams in a transport network, for example SDH or SONET, to a newly set-up packet-oriented network, for example IP or ATM. In this case, the addition of packet headers increases the capacity which is required for transmitting continuous information streams. If, for example, the continuous bit stream for an SDH fixed link uses a bit rate of 622 Mbps, then the bit stream has a bit rate of at least 687 Mbps after conversion to an ATM-oriented cell stream. If the transmission technology which is used on the physical links in the communications network is now, for example, limited to a maximum transmission capacity of 622 Mbps, the ATM-oriented cell stream cannot be transmitted in a single transmission channel, since the transmission capacity of the transmission technology used on the physical transmission channel is not sufficient. In this case, the information in such a traffic flow is split within a channel set which includes a number of transmission channels.

A further example is a channel set at the output of a switching matrix of a present-day switching system, which is required whenever the transmission capacity of the switching matrix and of the input and output stages (I/O stages) of the switching system is higher than the transmission capacity of the individual transmission channels using this connection technology between the switching matrix and the I/O stages which are connected. If, for example, the I/O stages have a capacity of 622 Mbps, and the transmission channels have a capacity of 155 Mbps, then, in principle, it is necessary to use a channel set having four transmission channels between the I/O stages and the switching matrix. If, furthermore, the switching matrix has a capacity of 5 Gbps, then eight pairs of I/O stages can be connected to the switching matrix. For this purpose and in this configuration example, the switching matrix has at least 32 input and 32 output ports, each for 155 Mbps. This is normally indicated by a suffix “32/32”, with the ports being addressed linearly using port addresses 0 . . . 31.

Normally, the splitting of a traffic stream between a number of channels upstream of the transmitter is concealed since a channel set is identified by a unique address; also referred to as the channel set address. During transmission, the transmitter identifies the traffic stream only by the unique channel set address. The splitting of the traffic stream between the individual channels of the indicated channel set takes place via a splitting function. This can be either separated from the transmitter or integrated in the transmitter. One example of a separated splitting function is the above switching system. In this case, a traffic stream from an input stage is identified using a channel set address, which leads to a specific output stage. The splitting function is in this case implemented in the switching matrix. This results in the switched traffic stream being split between the channels in the indicated cable set.

This functional separation between addressing, on the one hand, and splitting, on the other hand, results in the advantage that the number of channels associated with one channel set can be varied without needing to modify the addressing of the channel set in the transmitter. The fundamental precondition of the functionality of the splitting function is, of course, that the splitting function is aware of the association between the channels and the channel sets.

This functional separation offers major advantages when the above switching system is enlarged. This enlargement can be accomplished, without changing the hardware elements, by using what are referred to as parallel path switching matrices. In this case, a number of switching matrices are used within the switching system. The traffic streams in the input stages are split into a number of traffic stream elements corresponding to the number of switching matrices, and they are transmitted separately to the switching matrices, in order to achieve a uniform load level on the switching matrices. This reduces the number of transmission channels which are required between the I/O stages and a specific one of the switching matrices for each channel set. When using two 32/32 switching matrices in the above example, only two transmission channels are now required per channel set; when using four 32/32 switching matrices, a single transmission channel per channel set is sufficient. In general, it can be stated that, when using N/N switching matrices (N=2^{M}, 0≲M) and the maximum number K of identical capacity output stages (K=2^{L}, 0≲L≲M) which can be connected, each channel set includes up to N/K channels, with the ports of the switching matrices N/N normally being addressed linearly using addresses 0 . . . N−1. Such an enlargement now can be accomplished without any changes to the destination addresses in the transmitter. The precondition for this is that the addressing of the channel sets remains unchanged even if the number of channels per channel set changes. This can be implemented via an appropriately matched association between the channels and the channel sets.

A linear association between channels and the channel sets is known; that is, a number of channels with linearly successive channel addresses are, in each case, combined to form channel sets. This assumes that the N channels are identified by channel addresses 0. N−1. The channel sets are then each identified by the channel address of that channel which has the lowest channel address of all the channels included in the respective channel set. If, for example, a channel set includes the channels 4, 5, 6 and 7, then it is given the channel set address 4. A traffic stream which is sent to the channel set 4 (that is to say the channel set whose channel set address is 4) is split by the splitting function between the channels 4, 5, 6 and 7. For a 32/32 switching matrix (that is to say N=32) with a maximum of eight (that is to say K=8) output stages, this results, for example, in eight channel sets each having 32/8=4 channels in accordance with the following scheme:

1) Channel set 0 includes the channels 0-3.

2) Channel set 4 includes the channels 4-7.

8) Channel set 28 includes the channels 28-31.

However, this channel set formation process results in problems in communications networks where high system reliability is required. The required high system reliability is normally provided by a number of measures. One normal measure is for the switching matrices in the switching systems to be of redundant design. In a further measure, the output stages are connected to two redundant transmission paths in the communications network, and the traffic stream is transmitted simultaneously on both paths (this is referred to as 1+1 redundancy). This 1+1 redundancy is, however, normally provided optionally; that is, it is used only on a case-by-case basis. The output stages are normally installed in such a manner that each output stage can be selectively configured with or without 1+1 redundancy. If redundant transmission is dispensed with in such an output stage, then twice as much traffic can be transmitted by distributing the traffic stream between the two transmission paths that are still provided, than from an output stage in which 1+1 redundancy is activated. In consequence, either two cable sets having respectively N/K channels or a “duplicated” channel set with 2N/K channels must be connected to such an “unprotected” output stage, with the latter solution being more advantageous owing to the unique channel set addressing.

A linear association between channels and channel sets leads, however, when the switching matrices are enlarged, to a restriction in the free access capability from output stages with single and double throughput. This will be explained using an example. Five output stages are connected in the following configuration to a 32/32 switching matrix: 1) double, 2) double, 3) single, 4) single, 5) double. This leads to the following cable sets:

1) Channel set 0, including the channels 0-7.

2) Channel set 8, including the channels 8-15.

3) Channel set 16, including the channels 16-19.

4) Channel set 20, including the channels 20-23.

5) Channel set 24, including the channels 24-31.

After enlargement of the switching system by adding a second 32/32 switching matrix, these channel sets are formed as follows, after halving the number of associated channels:

1) Channel set 0 includes the channels 0-3.

2) Channel set 8 includes the channels 8-11.

3) Channel set 16 includes the channels 16-17.

4) Channel set 20 includes the channels 20-21.

5) Channel set 24 includes the channels 24-27.

After this conversion of the channel sets, additional channel sets 4, 6, 12, 14, 18, 22, 28 and 30 can be provided for the connection of new output stages. The disadvantage is that only the channel sets 4+6, 12+14 and 28+30 for doubled channel sets 4, 12 and 28 can be combined, but not the channel sets 18 and 22.

In consequence, only output stages with single throughput, that is to say with 1+1 redundancy and not with double throughput, can be connected to the channel sets 18 and 22. Again, the free access capability from output stages with single throughput and from output stages with double throughput is restricted.

An object of the present invention, therefore, is to improve the association between channels and channel sets.

### SUMMARY OF THE INVENTION

One major aspect of the present invention is a channel set system having the following features:

the system includes up to N channels where N=2^{M} and 0≲M, which are addressed using channel addresses 0 . . . N−1.

the channels are combined to form a maximum of K channel sets where K=2L and 0≲L≲M.

each channel set includes up to Y_{KB}*N/K channels, 1≲Y^{KB}≲K, where Y_{KB} is defined individually for each channel set.

the channel addresses of the channels which are combined to form a specific channel set are contained in the channel address area { (Z_{KB}+i)+j*K|0≲i≲Y_{KB}−1, 0≲j≲N/K−1}

where Z_{KB}, 0≲Z_{KB}≲K−Y_{KB}, is the channel address of the channel having the lowest channel address permissible for this channel set.

A number of major advantages of the present invention are as follows:

The number of channels assigned to one channel set can be configured highly flexibly since Y_{KB} is defined on a channel-set-specific basis.

When a channel set system is enlarged to more than N channels, each of the channel sets which are then additionally possible can be dimensioned independently of the already existing channel sets by virtue of the individual definition of Y_{KB}. If, for example, the channel set system is enlarged to 2*N channels, then having a maximum of 2*K channel sets, the additional channel sets can be formed using freely selectable channel address areas { (Z_{KB}+i)+j*k|0≦i≲Y_{KB}−1, 0≲j≲N/K−1} Z_{KB}, K≲Z_{KB}≲2*K−YKB.

Owing to the regularity of the channel address areas described by the formula, a channel set can be defined just by stating the values Z_{KB} and Y_{KB.} Advantageously, there is no absolute necessity for an individual association between channels and channel sets.

However, the channel sets can be dimensioned selectively and very finely, since underdimensioning is provided by non-assignment of individual channels.

In one embodiment of the channel set system according to the present invention, 1≲Y_{KB}≲2. This channel set system can be used particularly advantageously in systems in which high system reliability is achieved with the aid of single-redundant design of system components.

Another embodiment of the channel set system according to the present invention is characterized by the following further features:

the channels are grouped into 2^{X} channel groups each having N/2^{X} channels where 1≲X≲M, with each channel being allocated to one, and only one, channel group.

the channel groups are addressed linearly using group addresses 0 . . . 2^{X}−1.

the channels in each of the channel groups are addressed linearly using channel subaddresses 0 . . . N/2^{X}−1.

the channel address of a specific channel is obtained by placing the group address in front of the channel subaddress of the channel.

the channel subaddresses of the channels which are combined to form a specific channel set are contained in the channel subaddress area { (Z^{KB}+i)−5*K/2^{X}+j*K/2^{X}|0≲i≲Y_{KB}−1, 0≲j≲N/K−1} where Z_{KB}, 0≲Z_{KB}≲K−Y_{KB}, is the channel address of the channel having the lowest channel address permissible for this channel set, and S, 0≲S≲2^{X}−1, is the group address of the associated channel group.

This channel set system can be used particularly advantageously in switching devices in which switching modules N/N are provided by 2^{X} switching elements N/(N/2^{X}) since, in this case, identical channel subaddresses are used in each of the switching elements N/(N/2^{X}) and the switching elements N/(N/2^{X}) can be designed and configured identically.

According to one embodiment of the channel set system according to the present invention, the channel address Z^{KB}−S*K/2^{X} is, in each case, in the form of a channel set address of the associated channel set. Since 0≲Z_{KB}≲K−Y_{KB}, the channel set addresses are, thus, in principle taken from a linearly closed channel set address area {Z_{KB}}. In particular, if Y_{KB}=1 for each of the channel sets, the channel sets, of which there are then K, are addressed linearly using channel set addresses Z_{KB}, 0≲Z_{KB}≲K−1. This leads to a very simple channel set address scheme, which is compact and clear. Furthermore, when the channel set system is enlarged, the additional channel set addresses are taken from a channel set address area which is disjoined from the previous channel set address area {Z_{KB}|0≲Z_{KB}≲K−Y_{KB}}, for example, with the number of the channels being doubled for the channel set address area {Z_{KB}|K≲Z_{KB}≲2*K−Y_{KB}}.

One embodiment of the channel set system according to the present invention relates to a switching device having at least one input stage, at least one switching module having N input channels and N output channels, at least one output stage, and at least one channel set system for connecting the switching module to the output stages. This allows output stages with different throughputs to be connected as required to the switching modules.

According to one embodiment of the application according to the present invention, each switching module is connected to the output stages by a separate channel set system. This advantageously allows identical addressing schemes to be used in each switching module; that is, the switching modules can be designed and configured identically. Thus, for example, with switching modules of redundant design, sequential enlargement of the switching device is possible by the redundant switching modules only being enlarged once the enlargement of the primary switching modules has been completed.

One embodiment of the present invention provides that, in the case of a switching module which is implemented with two 2^{X} switching elements each having N input channels and N/2^{X} output channels, the addresses of the output channels of the switching elements are identical to the channel subaddresses. This obviates the need for an address matching function, which is otherwise required.

According to yet another embodiment of the application according to the present invention the value K/2^{X} and, at least for each channel set which is used, the value Y_{KB} are indicated to the switching module—claim 8. This allows the functional separation, described initially, of addressing and splitting of traffic streams, with the splitting being applied to the individual channels in the channel sets.

The present invention will be explained in more detail in the following text with reference to exemplary embodiments which are illustrated in the figures. In this case, in order to simplify the representation in all the figures, 1≲Y_{KB}≲2 is chosen, in which case the described exemplary embodiments can be generalized by an appropriate person skilled in the art without any problems for values of Y_{KB}≲2.

### BRIEF DESCRIPTION OF THE FIGURES

FIG. 1 shows set formation according to the present invention based on the example of a switching device having a switching module N/N.

FIG. 2 shows set formation according to the present invention using the example of a switching device having two switching modules N/N.

FIG. 3 shows a schematic illustration of an indication, according to the present invention, of the value K/2^{X} and of the values Y_{KB}.

FIG. 4 shows channel set systems according to the present invention in a switching device having two 32/32 switching modules.

FIG. 5 shows channel set systems according to the present invention in a switching device having four 32/32 switching modules, that is to say with double the throughput of the switching device illustrated in FIG. 4.

FIG. 6 shows an indication, according to the present invention, of the value K and of the values Y_{KB} for the channel set systems shown in FIG. 4.

FIG. 7 shows an indication, according to the present invention, of the value K and of the values Y_{KB} for the channel set systems as shown in FIG. 5.

FIG. 8 shows channel set systems according to the present invention in a switching device having two 32/32 switching modules, which are each in the form of two 32/16 switching elements.

FIG. 9 shows channel set systems according to the present invention in a switching device having four 32/32 switching modules, which are each in the form of two 32/16 switching elements, that is to say with twice the throughput of the switching device illustrated in FIG. 8.

FIG. 10 shows an indication, according to the present invention, of the value K/2^{X} and of the values Y_{KB} for the channel set systems shown in FIG. 8.

FIG. 11 shows an indication, according to the present invention, of the value K/2^{X} and of the values Y_{KB} for the channel set systems shown in FIG. 9.

### DETAILED DESCRIPTION OF THE INVENTION

The figures show, in some cases in generalized form, exemplary embodiments of the channel set systems KBS according to the present invention which are used, by way of example, in switching devices having input stages ES, output stages AS and intermediate switching modules KM for connecting the switching modules KM to the output stages AS. However, this usage should not be regarded as any limitation. It will be recognized to an appropriate person skilled in the art that the channel set system according to the present invention can be used in any desired systems. In particular, the term “channel” is not restricted to physical transmission channels and should be understood as meaning channels for connection technology in the form of cables. In fact, it also covers logical channels, for example in the form of ATM connections, TDMA channels or IP flows.

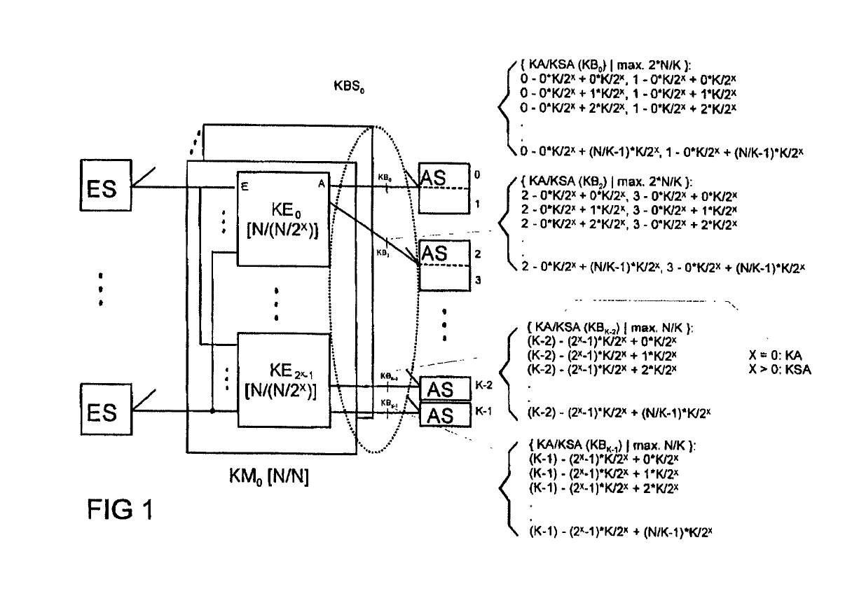

FIG. 1 shows, in generalized form and using the example of a switching device, the association between channels and channel sets in a channel set system KBS according to the present invention. The switching device includes a number of input stages ES, K output stages AS and an intermediate switching module KM [N/N], which is in the form of 2^{X} switching elements KE [N/(N/2^{X})]. The input stages ES are connected in parallel to N inputs E of each of the switching elements KE and the channels in the channel set system KBS are connected to N/2^{X} outputs A per switching element KE. The channel set system KBS in this exemplary embodiment is thus used for connecting the switching module KM [N/N] to the output stages AS. The channel sets KB include a maximum of Y_{KB}*N/K where Y_{KB} is defined individually for each channel set KB.

The output stages AS₀ and AS₂ are, for example, implemented without, redundancy, and the output stages AsK-2 and AsK-1 are implemented with 5 redundancy. The output stages AS₀ and AS₂ therefore transmit traffic streams with twice the throughput of the output stages AS_{K-2} and AS_{K-1}, that is to say Y_{KB}=2 for the output stages AS₀, AS₂ and Y_{KB}=1 for the output stages AS_{K-2}, AS_{K-1}. The output stage AS₀ is, in this case, connected by the channel set KB₀ to the switching element KE₀, the output stage AS₂ is connected by the channel set KB₂ to the switching element KE₀, the output stage AS_{K-2} is connected by the cable set KB_{K-2}, and the output stage AS_{K-1} by the cable set KB_{K-1}, to the switching element KE_{(2ˆ X)-1} of the switching module KM.

The cable sets KB_{0-KB}_{K-1} form the channel set system KBS which has N channels and in which the channels are addressed linearly in sequence using channel addresses KA, where KAε{0 . . . N−1}. The channel addresses KA of the channels which are combined to form a specific channel set KB are, in this case, contained in the following address areas:

Address area for channel set KB₀:

{0−0*K/2^{X}+0*K/2^{X}, 1−0*K/2^{X}+0*K/2^{X}

0−0*K/2^{X}+1*K/2^{X}, 1−0*K/2^{X}+1*K/2^{X};

0−0*K/2^{X}+2*K/2^{X}, 1−0*K/2^{X}+2*K/2^{X};

0−0*K/2^{X}+(N/K−1)*K/2^{X}, 1−0*K/2^{X}+(N/K−1)*K/2^{X}}.

Address area for channel set KB₂:

{2−0*K/2^{X}+0*K/2^{X}, 3−0*K/2^{X}+0*K/2^{X};

2−0*K/2^{X}+1*K/2^{X}, 3−0*K/2^{X}+0*K/2^{X};

2−0*K/2^{X}+0*K/2^{X}, 3−0*K/2^{X}+0*K/2^{X};

2−0*K/2^{X}+(N/K−1) *K/2^{X}, 3−0*K/2^{X}+(N/K−1)*K/2^{X}}.

Address area for channel set KB_{K-2}:

{ (K−2)−(2X−1)*K/2X+0*K/2X;

(K−2)−(2X−1)*K/2X+1*K/2X;

(K−2)−(2X−1)*K/2X+2*K/2X;

(K−2)−(2X−1)*K/2X+(N/K−1)*K/2X.

Address area for channel set KB_{K-1}:

{ (K−1)−(2^{X}−1)*K/2^{X}+0*K/2^{X};

(K−1)−(2^{X}−1)*K/2^{X}+1*K/2^{X};

(K−1)−(2^{X}−1)*K/2^{X}+2*K/2^{X};

(K−1)−(2^{X}−1)*K/2^{X}+(N/K−1)*K/2^{X}.

If X=0, then the switching module KM is in the form of a single switching element KE [N/N]. In this case, each of the address areas contains channel addresses KA. Since, in this case, (2^{X}−1)=0 as well then (represented in generalized form) the channel addresses KA of the channels which are combined to form a specific channel set KB contain { (Z_{KB}+i)+j*K|0≦i≲Y_{KB}−1, 0≲j≲N/K−1} in the channel address area, where Z_{KB}, 0≲Z≲K−Y_{KB}, the channel address KA of the channel having the lowest channel address KA which is permissible for this channel set KB. Z_{KB}, the channel set address of the associated channel set KB is, accordingly, in the present exemplary embodiment:

for the channel set KB₀: 0

for the channel set KB₂: 2

for the channel set KB_{K-2}: K−2

for the channel set KB_{K-1}: K−1

If X>0, then the switching module KM is in the form of 2^{X} switching elements KE [N/(N/2^{X})]. In this case, the channels are grouped into 2^{X} channel groups of N/2^{X} channels each, to match the number of switching elements KE, with the channel groups being addressed linearly using group addresses GA where GAε{0 . . . 2^{X}−1}, and the channels in each of the channel groups being addressed linearly using channel subaddresses KSA where KSAε{0 . . . N/2^{X}−1}. The channel address KA is, in this case, obtained by placing the group address GA in front of the channel subaddress KSA of the channel. Each of the above address areas then contains channel subaddresses KSA. Since, in addition, (2^{X}−1)>0, then (represented in generalized form) the channel subaddresses KSA of the channels which are combined to form a specific channel set KB are contained in the channel subaddress area {(Z_{KB}+i)−S*K/2^{X}+j*K/2^{X}|0≲i≲Y_{KB}−1, 0≲j≲N/K−1},

where Z_{KB}, 0≲Z≲K−Y_{KB}, the channel subaddress KA of the channel having the lowest channel address KA which is permissible for this channel set KB, and S, 0≦S≲2X−1, is the group address GA of the associated channel group. Z_{KB}−S*K/2^{X}, the channel set address of the associated channel set KB is, in this case:

for the channel set KB₀: 0

for the channel set KB₂: 2

for the channel set KB_{K-2}: K/2^{X}−2=[(K−2)−(2ₓ−1)*K/2^{X}]

for the channel set KB_{K-1}: K/2^{X}−1=[(K−1)−(2ₓ−1)*K/2^{X}]

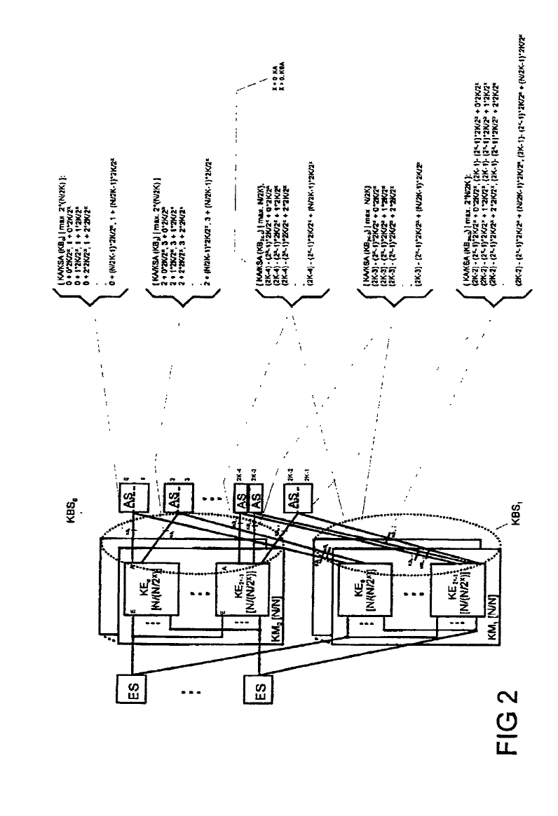

The value K/2^{X} from the formula (see FIG. 2) which describes the channel subaddress areas, and the value K (=K/2^{X} where X=0) from the formula (see FIG. 1) which describes the channel address areas are also referred to as the step width. Owing to the sudden changes, associated with this, in the address areas, the channel sets KB according to the present invention are also referred to as “intermittent” channel sets KB.

FIG. 2 uses a further exemplary embodiment, which has been kept in generalized form, to show the same switching device as that in FIG. 1, but enlarged by the addition of a second switching module KM₁ which is physically identical to the switching module KM₀. Each of the two switching modules KM is, in this, case connected by a separate channel set system KBS to the output stages AS, with both channel set systems KBS being designed identically owing to the symmetrical arrangement of the switching modules KM. As a result of the enlargement, up to 2K output stages AS are now possible. In a corresponding way, each of the channel set systems KBS in this exemplary embodiment may include up to 2K channel sets KB. The size of the individual channel sets KB is, in this case, reduced to N/2 K channels. The address areas of the individual channel sets KB and the corresponding channel set addresses KBA are obtained by inserting the value 2 K for the value K in the formulae from FIG. 1.

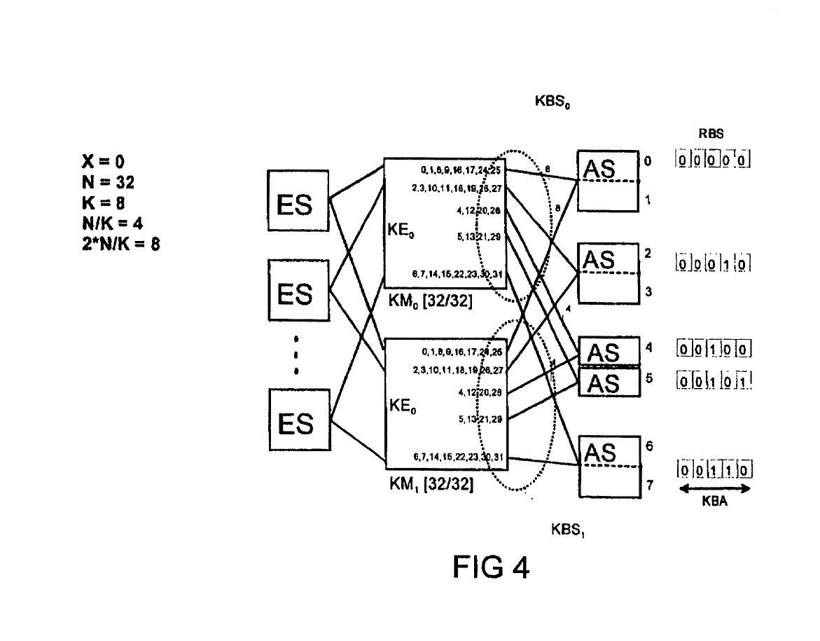

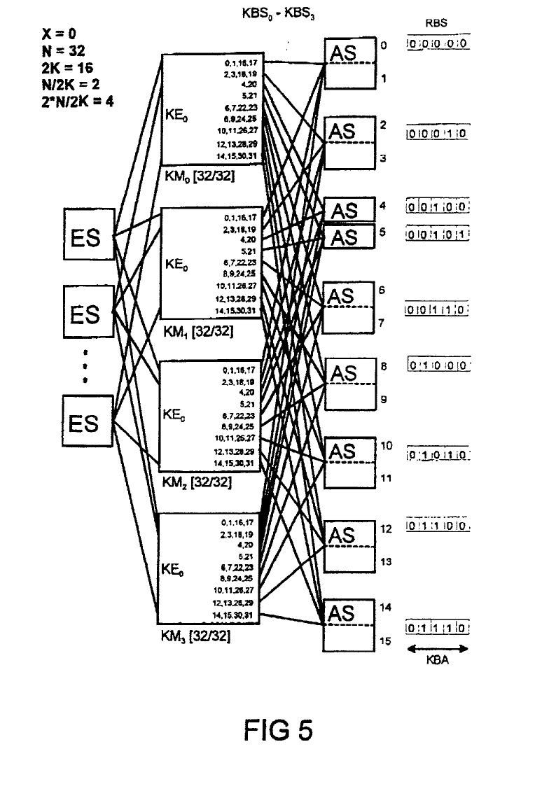

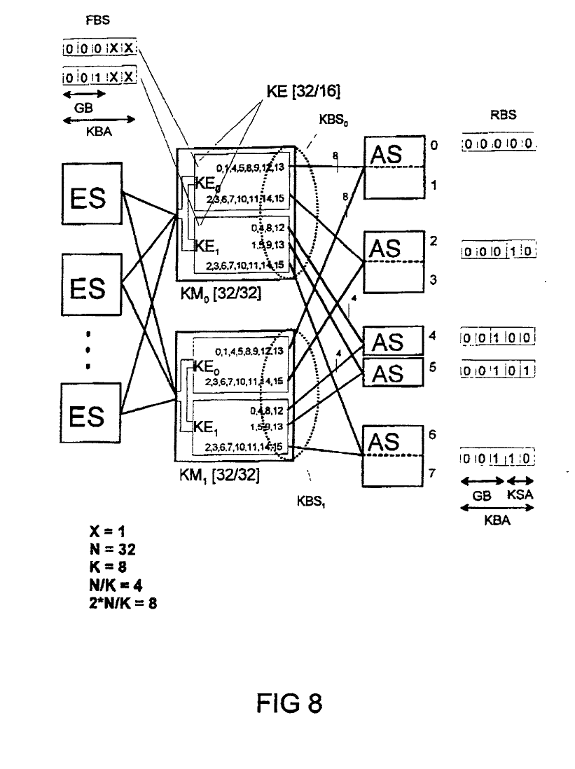

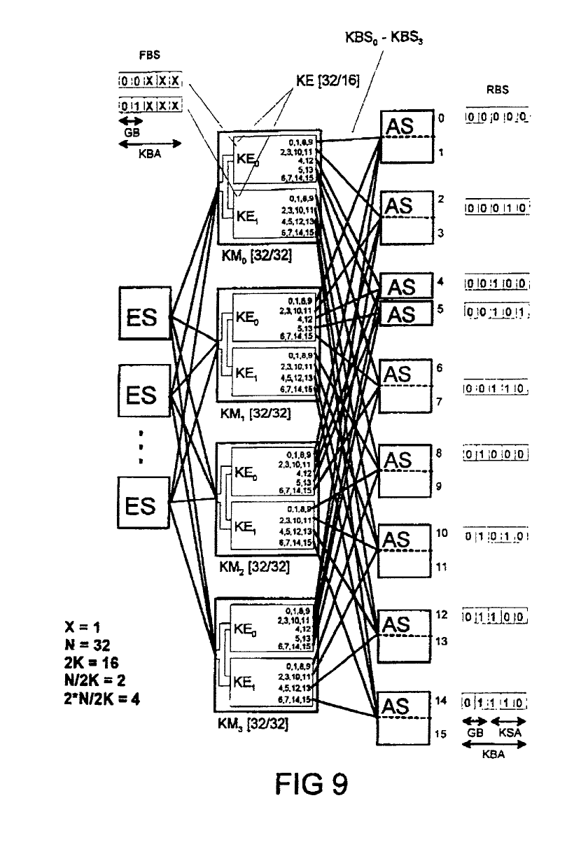

FIGS. 4, 5, 8, and 9 show further exemplary embodiments which have been kept in specific form. In this case, FIGS. 4 and 8 each refer to a switching device having two switching modules KM₀₋₁[32/32] (that is to say N=32) which, in FIGS. 5 and 9, each have two further switching modules KM₂₋₃ [32/32] added to them. In FIGS. 4 and 5, the switching modules KM are each provided by a respective switching element KE [32/32] (that is to say X=0) while, in FIGS. 8 and 9, the switching modules KM are each provided by two switching elements KE [32/16] (that is to say X=1). Before the enlargement, five output stages AS in each of the two switching devices are connected to the switching modules KM₀-KM₁ in the following configuration: 1) double, 2) double, 3) single, 4) single and 5) double throughput. In this case, the output stages AS are dimensioned such that all the outputs A of the switching modules KM are used (that is to say K=8).

The address areas of the channel sets KB can, thus be derived from the formulae illustrated in FIGS. 1 and 2, by inserting the following values:

FIG. 4: X=0, N=32, K=8 into the formulae from FIG. 1

FIG. 5: X=0, N=32, 2K=16 into the formulae from FIG. 2 or K=16 in the formulae from FIG. 1

FIG. 8: X=1, N=32, K=8 into the formulae from FIG. 1

FIG. 9: X=1, N=32, 2K=16 into the formulae from FIG. 2 or K=16 into the formulae from FIG. 1

For example in the switching device shown in FIG. 4, this leads to the following channel sets KB:

1) Channel set KB₀ with channels 0, 1, 8, 9, 16, 17, 24, 25

2) Channel set KB₂ with channels 2, 3, 10, 11, 18, 19, 26, 27

3) Channel set KB₄ with channels 4, 12, 20, 28

4) Channel set KB₅ with channels 5, 13, 21, 29

5) Channel set KB₆ with channels 6, 7, 14, 15, 22, 23, 30, 31

Once a second switching module KM [32/32] has been added to the switching system (see FIG. 5) these channel sets KB are formed by halving the number of associated channels, as follows:

1) Channel set KB₀ with channels 0, 1, 16, 17

2) Channel set KB₂ with channels 2, 3, 18, 19

3) Channel set KB₄ with channels 4, 20

4) Channel set KB₅ with channels 5, 21

5) Channel set KB₆ with channels 6, 7, 22, 23

This shows very well that, in this case, the step width K has been doubled from the original K=8 to K=16.

Following this conversion of the channel sets KB, additional channel sets KB₈₋₁₅ now can be connected for connection of new output stages KS, in which case, since the value Y_{KB} (which defines the maximum number of channels per channel set KB) can be defined individually for each channel set KB, the switching device can be enlarged as required either by output stages AS with single throughput or output stages ES with double throughput. By way of example, FIGS. 5 and 9 show the addition of four output stages AS with double throughput which, in the switching device shown in FIG. 5, leads to the following additional channel sets KB:

6) Channel set KB₈ with channels 8, 9, 24, 25

7) Channel set KB₁₀ with channels 10, 11, 26, 27

8) Channel set KB₁₂ with channels 12, 13, 28, 29

9) Channel set KB₁₄ with channels 14, 15, 30, 31

Analogously, the insertion of the above values in the switching device as shown in FIG. 8 leads to the following channel sets KB:

1) Channel set KB₀ with channels 0, 1, 4, 5, 8, 9, 12, 13

2) Channel set KB₂ with channels 2, 3, 6, 7, 10, 11, 14, 15 with a connection to the two switching elements KEO, and

3) Channel set KB₀ with channels 0, 4, 8, 12

4) Channel set KB₁ with channels 1, 5, 9, 13

5) Channel set KB₂ with channels 2, 3, 6, 7, 10, 11, 14, 15 with a connection to the two switching elements KE₁.

Once a second switching module KM [32/32] has been added to the switching system (see FIG. 9) these channel sets KB are formed by halving the number of associated channels, as follows:

1) Channel set KB₀ with channels 0, 1, 8, 9

2) Channel set KB₂ with channels 2, 3, 10, 11

3) Channel set KB₄ with channels 4, 12

4) Channel set KB₅ with channels 5, 13

5) Channel set KB₆ with channels 6, 7, 14, 15

with a connection to the four switching elements KE₀.

It easily can be seen that, in this case, the step width K/2^{X} has been doubled from the original K=4 to K=8. Furthermore, it can be seen that the two step widths are half as large as those for the switching devices illustrated in FIGS. 4 and 5. This takes account of the fact that the 32/16 switching elements have only half as many outputs A as the 32/32 switching elements.

After this conversion of the channel sets KB, additional channel sets KB_{0-7 (8-15)} can be connected in order to connect new output stages AS to the four switching elements KE₁. In this case, since the value Y_{KB} (which defines the maximum number of channels per channel set KB) can be defined individually for each channel set KB, the switching device can be enlarged as required by adding either output stages AS with single throughput or output stages AS with double throughput. By way of example, FIG. 5 and FIG. 9 show an enlargement by the addition of four output stages AS with double throughput, which leads to the following additional channel sets KB in the switching device shown in FIG. 9:

6) Channel set KB_{0 (8)} with channels 0, 1, 8, 9

7) Channel set KB_{2 (10)} with channels 2, 3, 10, 11

8) Channel set KB_{4 (12)} with channels 4, 5, 12, 13

9) Channel set KB_{6 (14)} with channels 6, 7, 14, 15

with a connection to the four switching elements KE1.

The differences in the addressing result from the fact that a channel address KA for X>0 is formed by placing the group address GA in front of the channel subaddress KSA of the channel. Thus, firstly, the traffic streams in the input stages ES can be characterized in accordance with a routing bit scheme RBS, which is implemented in a standard manner using channel addresses KA, that is to say independently of the value X and, thus, independently of the implementation of the switching modules KM and, secondly, the traffic streams can be switched in the switching elements KE in a standard manner with the aid of an addressing scheme which in each case starts with the channel subaddress 0. The distribution of the traffic streams between the corresponding switching elements KEGA is carried out with the aid of the group addresses GA by what is referred to as a filter bit scheme FBS. The respective routing bit scheme RBS is indicated in FIGS. 4, 5, 8 and 9 for all the output stages AS, and the respective filter bit scheme FBS is indicated for each of the switching modules KM in both FIGS. 8 and 9.

In the switching elements KE, the traffic streams are identified in a standard manner just by channel set addresses KBA. Since the association between the channels and the channel sets KB may change in the course of the reconfiguration of a channel set system KBS as is shown, for example, for the enlargement of the switching device, an indication of the value K/2^{X} (step width) and of the values Y_{KB} is required for the splitting function which is provided in the switching elements KE and via which the switched traffic streams are split between the individual channels in a channel set KB, by which the respective current association between the channels and the channel sets KB is sufficiently well described.

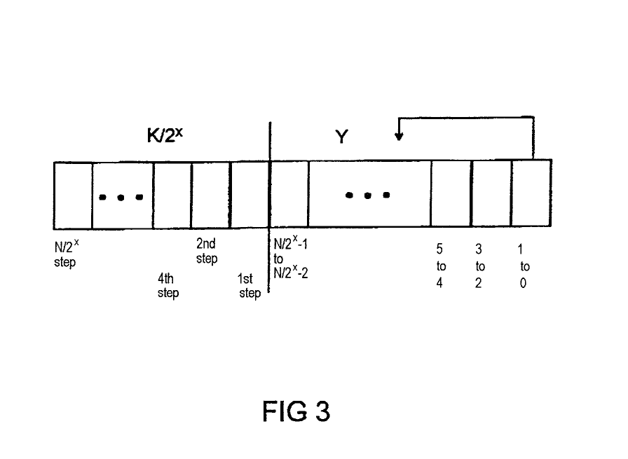

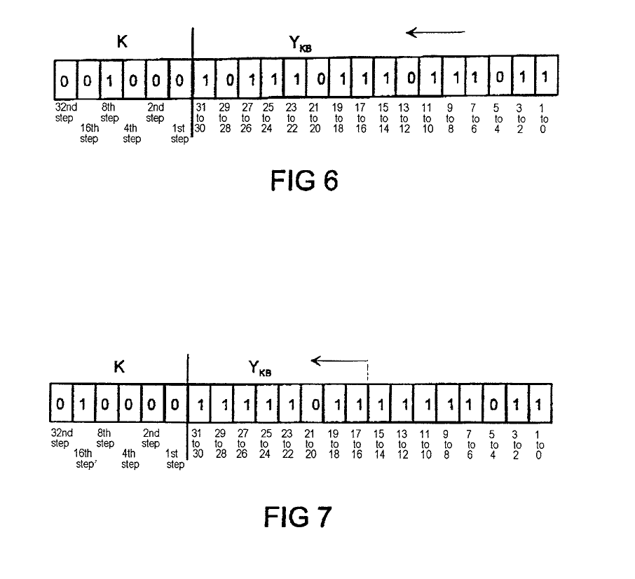

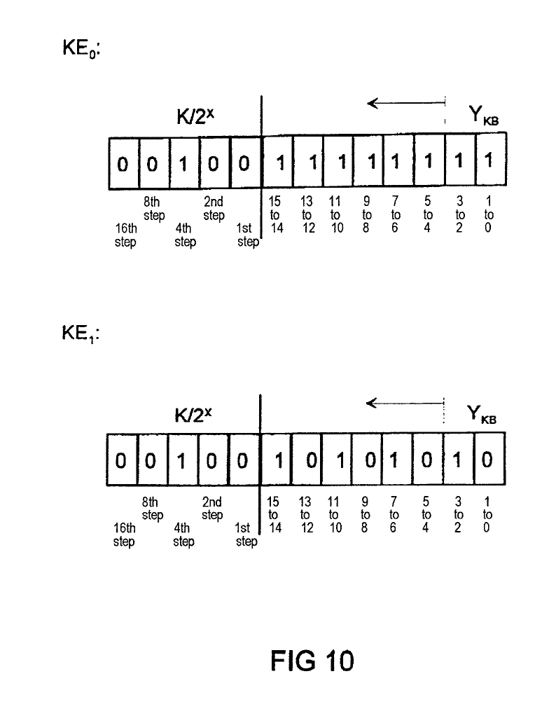

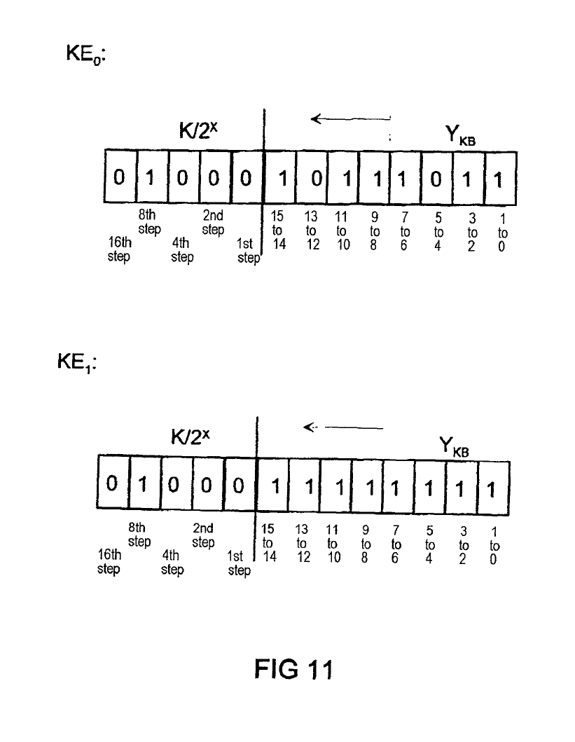

FIG. 3 in this context shows one option for indication of the values. In this case, firstly, one bit is in each case used for each channel set KB with an even-numbered channel set address KBA to indicate whether the associated output stage AS is transmitting traffic streams with single (that is to say, Y=1) or double (that is to say, Y=2) throughput, with a bit value of 0 indicating double throughput, and a bit value of 1 indicating single throughput. A total of N/2^{X+1} bits is required for this purpose; that is, for example, 16 bits for a switching element KE [32/32] (see also FIGS. 6 and 7), and, for example, 8 bits for a switching element KE [32/16] (see also FIGS. 10 and 11). The step width K/2^{X} is indicated, for example, by providing one bit for each permissible step width and by indicating the step width that is set by a bit value 1, with one and only one of the bits having this value at each time, and all the other bits having a bit value 0. Both bit sequences could, for example, be stored in a register which, for example, is provided in each of the switching elements KE.

This bit sequence is sketched, for example, in FIG. 6 for the switching device illustrated in FIG. 4, in FIG. 7 for the switching device illustrated in FIG. 5, in FIG. 10 for the switching device illustrated in FIG. 8, and in FIG. 11 for the switching device illustrated in FIG. 9. In this case, since X=1 in FIGS. 10 and 11, two bit sequences are in each case illustrated, one for the switching elements KE₀ and one for the switching elements KE₁. In all the bit sequences, the cyclic repetition in the bits which indicate the value Y_{KB} correspond to the respective step width.

The addresses of the N/2^{X} outputs A of the switching elements KE are advantageously identical to the channel subaddresses in all the described switching devices. There is, thus, no need for the address matching function which is otherwise required.

Although the present invention has been described with reference to specific embodiments, those of skill in the art will recognize that changes may be made thereto without departing from the spirit and scope of the invention as set forth in the hereafter appended claims.

1. A channel set system comprising:
up to N channels, where N=2^{M} and 0≲M, which are addressed using channel addresses; and
a maximum of K channel sets, formed from a combination of the channels, where K=2^{L} and 0≲L≲M, each channel set including up to Y_{KB}*N/K channels, 1≲Y_{KB}≲K, where YKB is defined individually for each channel set, and the channel addresses of the channels which are combined to form a specific channel set are contained in a channel address area (Z_{KB}+i)+j*K|0≲i≲Y_{KB}−1, 0≲j≲N/K−1} where Z_{KB}, 0≲Z≲K−Y_{KB}, is the channel address of the channel having a lowest channel address permissible for the specific channel set.

2. A channel set system as claimed in claim 1, wherein 1≲Y_{KB}≲2.

3. A channel set system as claimed in claim 1, further comprising:
2^{X} channel groups, each of the channel groups having N/2^{X} channels where 1≲X≲M, with each channel being allocated to only one channel group, the channel groups being addressed linearly using group addresses 0 . . . 2^{X}−1, the channels in each of the channel groups also being addressed linearly using channel subaddresses 0 . . . N/2^{X}−1, the channel address of a specific channel being obtained by placing the respective group address in front of the channel subaddress of the specific channel, the channel subaddresses of the channels which are combined to form a specific channel set being contained in a channel subaddress area {(Z_{KB}+i)−5*K/2^{X}+j*K/2^{X}|0≲i≲Y_{KB}−1, 0≲j≲N/K−1} where Z_{KB}, 0≲Z_{KB}≲K−Y_{KB}, is the channel address of the channel having the lowest channel address permissible for this channel set, and S, 0≲S≲2^{X}−1, is the group address of the associated channel group.

4. A channel set system as claimed in claim 3, wherein Z_{KB}−S*K/2^{X} is in each case in the form of the channel set address of the associated channel set.

5. A switching device, comprising:
at least one input stage;
at least one switching module having N input channels and N output channels, at least one output stage; and
at least one channel set system for connecting the switching module to the output stages, the channel set system further comprising:
up to N channels, where N=2^{M} and 0≲M, which are addressed using channel addresses; and
a maximum of K channel sets, formed from a combination of the channels, where K=2^{L} and 0≲L≲M, each channel set including up to Y_{KB}*N/K channels, 1≲Y_{KB}≲K, where Y_{KB} is defined individually for each channel set, and the channel addresses of the channels which are combined to form a specific channel set are contained in a channel address area (Z_{KB}+i)+j*K|0≲i≲Y_{KB}−1, 0≲j≲N/K−1} where Z_{KB}, 0≲Z≲K−Y_{KB}, is the channel address of the channel having a lowest channel address permissible for the specific channel set.

6. A switching device as claimed in claim 5, wherein each of the at least one switching module is connected to the at least one output stage by a separate channel set system.

7. A switching device as claimed in claim 5 wherein the at least one channel set system further comprises:
2^{X} channel groups, each of the channel groups having N/2^{X} channels where 1≲X≲M, with each channel being allocated to only one channel group, the channel groups being addressed linearly using group addresses 0 . . . 2^{X}−1, the channels in each of the channel groups also being addressed linearly using channel subaddresses 0 . . . N/2^{X}−1, the channel address of a specific channel being obtained by placing the respective group address in front of the channel subaddress of the specific channel, the channel subaddresses of the channels which are combined to form a specific channel set being contained in a channel subaddress area {(Z_{KB}+i)−5*K/2^{X}+j*K/2^{X}|0≲i≲Y_{KB}31 1, 0≲j≲N/K−1} where Z_{KB}, 0≲Z_{KB}≲K−Y_{KB}, is the channel address of the channel having the lowest channel address permissible for this channel set, and S, 0≲S≲2^{X}−1, is the group address of the associated channel group; and
wherein, in the case of a switching module which is implemented with two 2^{X} switching elements each having N input channels and N/2^{X} output channels, the addresses of the output channels of the switching elements are identical to the channel subaddresses.

8. A switching device as claimed in claim 5, wherein the at least one channel set system further comprises:
2^{X} channel groups, each of the channel groups having N/2^{X} channels where 1≲X≲M, with each channel being allocated to only one channel group, the channel groups being addressed linearly using group addresses 0 . . . 2^{X}−1, the channels in each of the channel groups also being addressed linearly using channel subaddresses 0 . . . N/2^{X}−1, the channel address of a specific channel being obtained by placing the respective group address in front of the channel subaddress of the specific channel, the channel subaddresses of the channels which are combined to form a specific channel set being contained in a channel subaddress area {(Z_{KB}+i)−5*K/2^{X}+j*K/2^{X}|0≲i≲Y_{KB}−1, 0≲j≲N/K−1} where Z_{KB}, 0≲Z_{KB}≲K−Y_{KB}, is the channel address of the channel having the lowest channel address permissible for this channel set, and S, 0≲S≲2^{X}−1, is the group address of the associated channel group; and
wherein the value K/2^{X} and, at least for each channel set which is used, the value Y_{KB} are indicated to the at least one switching module.
